(19) United States
(12) Patent Application Publication
(10) Pub. No.: US 2007/0189771 A1
(43) Pub. Date: Aug. 16, 2007

(54) EPON system and method for setting up bandwidth therein

(76) Inventor: Su-Hyung Kim, Seoul (KR)

Correspondence Address: Robert E. Bushnell, Suite 300, 1522 K. Street, N.W., Washington, DC, 20005-1202, US

(21) Appl. No.: 11/638,569

(22) Filed: Dec. 14, 2006

(30) Foreign Application Priority Data
Feb. 13, 2006 (KR) 10-2006-0013903

(51) Int. Cl. H04J 14/00

(52) U.S. Cl. 398/69

(57) ABSTRACT

In an Ethernet passive optical network (EPON) system and a method for setting up a bandwidth therein, the EPON system comprises at least one optical network unit (ONU) for transmitting to an optical line termination (OLT) a registration request message containing information about a set second bandwidth when a discovery gate message according to a multi point control protocol (MPCP) is received. The OLT registers the ONU therein according to information about a set first bandwidth and the information about the second bandwidth contained in the registration request message received from the ONU. The EPON system registers only the ONU having an optimum bandwidth in a network environment where the OLT and the ONU have different bandwidths from each other.

### CLAIM OF PRIORITY

This application makes reference to, incorporates the same herein, and claims all benefits accruing under 35 U.S.C. § 119 from an application for METHOD AND APPARATUS FOR SETTING UP BANDWIDTH IN EPON SYSTEM earlier filed in the Korean Intellectual Property Office on the 13^{th} of February 2006 and there duly assigned Serial No. 10-2006-0013903.

### BACKGROUND OF THE INVENTION

1. Technical Field

The present invention relates to an Ethernet passive optical network (EPON) system and a method for setting up a bandwidth therein.

2. Related Art

A passive optical network (PON) system has a subscriber network structure which connects a plurality of optical network units (ONUs) to one optical fiber termination (OLT) using a splitter to form a distribution topology of a tree structure.

The PON system can reduce the length of the whole optical fiber, can construct a reliable and inexpensive optical access network, and can combine and multiplex signals between subscribers for transmission to a high speed backbone network. Thus, such a system is suitable for fiber to the home (FTTH) and fiber to the curb (FTTC).

The PON system comprises four components: optical fiber termination (OLT); optical distribution network (ODN); optical network unit (ONU); and element management system (EMS).

The OLT functions as a concentration switch between a PON and a backbone network, and the EMS operates, runs and maintains the PON system, and monitors the performance of the PON system.

The typical OLT is presumed to have the EMS function. This is in order to concentrate all functions of the PON system in the OLT so as to reduce the functional and economic burden of the ONU, leading to low maintenance and installation costs of the PON system.

The ODN comprises only passive optical components such as a fiber, a splitter, and an optical connector, and it has a bus or tree structure.

The ONU is connected directly to the subscriber network, and its location is changed depending on applications such as fiber to the building (FTTB), fiber to the curb (FTTC), fiber to the office (FTTO), and fiber to the home (FTTH).

As PON systems, various technologies such as a broadband PON (BPON) system, a Gigabit-capable passive optical network (GPON) system, an Ethernet passive optical network (EPON) system, and a wavelength division multiplexing passive optical network (WDMPON) system were developed or are being developed. Of these, the EPON system uses a widely spread Ethernet technology, and is low in Ethernet equipment cost and optical infrastructure cost, and thus it is gradually getting attention in a wideband high-speed subscriber network.

The typical EPON system uses the OLT and the ONU which have a bandwidth of 1 Giga bits, and service is provided at a data rate of 1 Gbps (ins per bit) for both up and down links. However, it can actually use a bandwidth smaller than 1 Gigabit due to overhead, such as dynamic bandwidth allocation (DBA), multi point control protocol/Administration and Maintenance (MPCP/OAM) frame, and optical parameters.

As the EPON system attracts more attention, standardization for a PON system of a 2 Gigabit-level is currently proceeding.

The typical EPON system uses a transceiver having a line rate of 1.25 Gbps (0.8 ns per bit) and provides service at a data rate of 1 Gbps (1 ns per bit). However, a broader downstream bandwidth is required in order to simultaneously provide a MPEG-2 HD tier (19.4 Mbps/ch) IPTV service and a VOD service of the same tier. According to a CISCO guide line, 737 Mbps is required as a downstream video bandwidth. Thus, there is an urgent need for an EPON system of a 2 Gigabit level (hereinafter, “2G EPON”).

After the 2G EPON system is developed, it should be used together with the 1G EPON system. In this case, however, there is no method for making the two EPON systems compatible and no management method for the two EPON systems.

For example, when a 2G EPON OLT is used together with a 1G ONU and down-link data are transmitted from the 2G EPON OLT to the 1G ONU, the 1G ONU cannot receive all the data due to its insufficient bandwidth, causing data loss.

Also, when a 1G EPON OLT is used together with 1G and 2G ONUs and up-link data are transmitted from the 2G ONU to the 1G EPON OLT, the OLT cannot receive all of the data due to its insufficient bandwidth, causing data loss.

### SUMMARY OF THE INVENTION

It is an object of the present invention to provide an Ethernet passive optical network (EPON) system and a method for setting up a bandwidth therein, the system and method being capable of preventing data loss resulting from a bandwidth difference by performing a registration procedure on an optical fiber termination (OLT) and an optical network unit (ONU) of a 1G EPON system, and an OLT and an ONU of a 2G EPON system, depending on their bandwidths.

One aspect of the present invention provides an EPON system, comprising at least one ONU for transmitting to an OLT a registration request message containing information about a set second bandwidth when a discovery gate message according to a multi point control protocol (MPCP) is received, wherein the OLT registers the ONU therein according to information about a set first bandwidth and the information about the second bandwidth contained in the registration request message received from the ONU.

The ONU preferably produces the registration request message which contains the information about the second bandwidth in a predetermined byte size field.

The OLT preferably registers the ONU therein if the first bandwidth is identical to the second bandwidth, but otherwise does not register the ONU.

The ONU preferably comprises an optical signal processor for converting an optical signal received via an optical fiber into parallel data which are electrical signals, and for line-decoding the parallel data; a media access control (MAC) processor for MAC-processing the parallel data, and for providing an Ethernet frame or an Internet protocol (IP) packet to a subscriber terminal device; and a bandwidth setup unit for recognizing the second bandwidth of the ONU, and for producing the registration request message containing the information about the second bandwidth when the discovery gate message is received.

The OLT preferably comprises: a frame processor for performing MAC protocol processing on an Ethernet frame received from a network according to an IEEE 802.3ah standard; an optical signal processor for line-coding the MAC protocol-processed Ethernet frame, and for converting the Ethernet frame into a serial signal and transmitting the serial signal to an optical fiber; and a bandwidth allocator for broadcasting the discovery gate message via the optical fiber, for comparing the second bandwidth contained in the registration request message received from the ONU to the first bandwidth of the OLT, and for registering the ONU therein and transmitting a registration message containing link identification information when the first and second bandwidths are identical to each other.

The OLT preferably allocates an up-link data transmission time of the registered ONU and transmits to the ONU a standard gate message containing information about the time.

The EPON system preferably further comprises a splitter which is located between the OLT and the ONU, and which splits the optical signal exchanged via the optical fiber so as to connect the OLT and at least one ONU.

Another aspect of the present invention provides an EPON system, comprising: an OLT for broadcasting a discovery gate message containing information about a set first bandwidth; and at least one ONU for recognizing the information about the first bandwidth contained in the discovery gate message received from the OLT, for comparing information about a set second bandwidth to the information about the first bandwidth, and for transmitting a registration request message when the information about the first bandwidth is identical to the information about the second bandwidth; wherein said at least one ONU does not register in the OLT if the information about the first bandwidth width is not identical to the information about the second bandwidth.

The OLT preferably produces the discovery gate message which contains the information about the first bandwidth in a predetermined byte size field.

The OLT preferably comprises: a frame processor for performing MAC protocol processing on an Ethernet frame received from a network according to an IEEE 802.3ah standard; an optical signal processor for line-coding the MAC protocol-processed Ethernet frame, and for converting the Ethernet frame into a serial signal and transmitting the serial signal to an optical fiber; and a bandwidth allocator for broadcasting the discovery gate message containing information about the first bandwidth via the optical fiber; wherein, when the registration request message is received from the ONU, the optical signal processor registers the corresponding ONU in the OLT, transmits a registration message containing link identification information to the corresponding ONU, and transmits to the ONU a standard gate message containing up-link data transmission time information allocated to the ONU.

The ONU preferably comprises: an optical signal processor for converting an optical signal received via an optical fiber into parallel data which are electrical signals, and for line-decoding the parallel data; a MAC processor for MAC-processing the parallel data, and for providing an Ethernet frame or an IP packet to a subscriber terminal device; and a bandwidth setup unit for transmitting the registration request message to the OLT when the information about the second bandwidth of the ONU is identical to the information about the first bandwidth contained in the discovery gate message, but otherwise not registering in the OLT.

Still another aspect of the present invention provides a method for setting up a bandwidth in an EPON system which includes at least one ONU and an OLT, the method comprising the steps of: transmitting, at the ONU, a registration request message containing information about a second bandwidth set to the ONU, the message being transmitted to the OLT when a discovery gate message according to an MPCP is received; comparing, at the OLT, information about the second bandwidth contained in the registration request message to information about a first bandwidth set to the OLT; and registering, at the OLT, the ONU therein, and transmitting, at the OLT, a registration message when the first bandwidth is identical to the second bandwidth.

The registration request message preferably comprises the information about the second bandwidth in a predetermined byte size field.

The method preferably further comprises the step of, at the OLT, not registering the ONU therein when the first bandwidth is not identical to the second bandwidth.

The method preferably further comprises the steps of: at the OLT, registering the ONU therein and transmitting the registration message containing link identification information; at the OLT, allocating an up-link data transmission time of the registered ONU, and transmitting to the ONU a standard gate message containing information about the time; and, at the ONU, transmitting a registration acknowledgment message to the OLT.

The method preferably further comprises the steps of: at the OLT, performing MAC protocol processing on an Ethernet frame received from a network according to an IEEE 802.3ah standard; at the OLT, line-coding the MAC protocol-processed Ethernet frame, converting the Ethernet frame into a serial signal, and transmitting the serial signal to an optical fiber; and at the ONU, converting the optical signal received via an optical fiber into parallel data which are electrical signals, and line-decoding the parallel data; and at the ONU, MAC-processing the parallel data, and providing an Ethernet frame or an IP packet to a subscriber terminal device.

Yet another aspect of the present invention provides a method for setting up a bandwidth in an EPON system which includes at least one ONU and an OLT, the method comprising the steps of: at the OLT, broadcasting a discovery gate message containing information about a first bandwidth set to the OLT; at the ONU, identifying information about the first bandwidth from the discovery gate message; and at the ONU, transmitting a registration request message to the OLT when information about a first bandwidth set to the ONU is identical to the information about the second bandwidth.

The discovery gate message preferably comprises the information about the first bandwidth in a predetermined byte size field.

The method preferably further comprises the step of not transmitting the registration request message when the information about the first bandwidth is not identical to the information about the second bandwidth.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a network diagram of an Ethernet passive optical network (EPON) system according to an exemplary embodiment of the present invention;

FIG. 2 is a block diagram of an EPO system according to an exemplary embodiment of the present invention;

FIG. 3 is a diagram illustrating a registration request message according to an exemplary embodiment of the present invention;

FIG. 4 is a diagram illustrating a discovery gate message according to an exemplary embodiment of the present invention;

FIG. 5 is a flow diagram of a registration procedure of an EOP system;

FIG. 6 is a flow diagram of a registration procedure according to a first exemplary embodiment of the present invention;

FIG. 7A is a flowchart of the registration procedure according to the first exemplary embodiment of the present invention;

FIG. 7B is a state diagram illustrating that an optical network unit (ONU) transmits a registration request message according to the first exemplary embodiment of the present invention;

FIG. 8 is a flow diagram of a registration procedure according to a second exemplary embodiment of the present invention;

FIG. 9A is a flowchart of the registration procedure according to the second exemplary embodiment of the present invention;

FIG. 9B is a state diagram illustrating that an ONU transmits a registration request message; and

FIG. 9C is a state diagram illustrating ONU processing according to a bandwidth.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

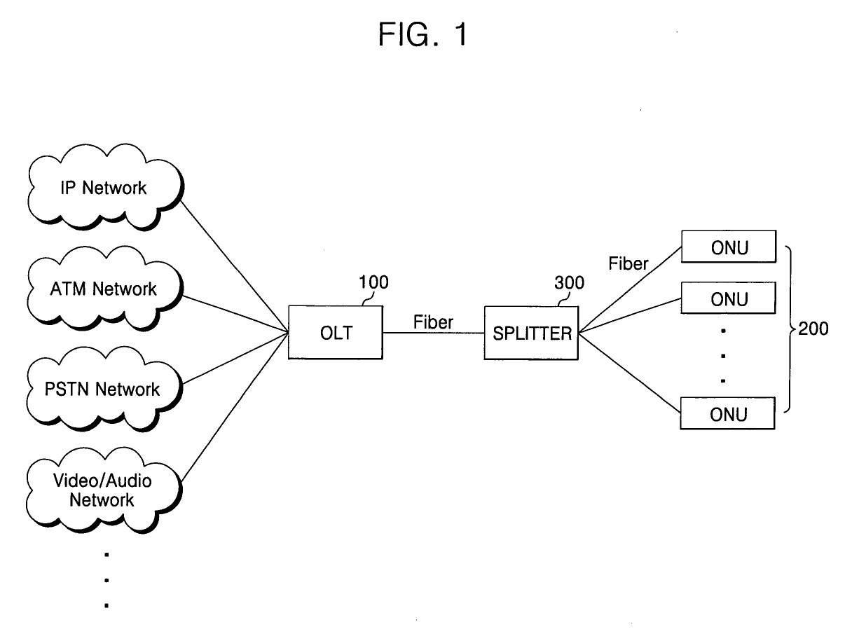

FIG. 1 is a network diagram of an Ethernet passive optical network (EPON) system according to an exemplary embodiment of the present invention.

Referring to FIG. 1, the EPON system of the present invention comprises an optical fiber termination (OLT) 100, a splitter 300, and a plurality of optical network units (ONUs) 200.

The OLT 100 may be connected to a network of at least one type such as an Internet protocol (IP) network, an asynchronous transfer mode (ATM) network, a public switched telephone network (PSTN) network, or a video/audio network.

The OLT 100 processes an Ethernet frame received from the network, converts it to an optical signal and transmits the optical signal to the splitter 300 via an optical fiber.

The OLT 100 receives an Ethernet frame and performs media access control (MAC) protocol processing on it according to an IEEE 802.1 ah standard. The OLT 100 also performs line-coding on the MAC-processed Ethernet frame so as to be suitable for an optical fiber, converts them into serial signals for high speed serial communication, and outputs them to the splitter 300 via the optical fiber.

The optical signal is converted into an optical signal of 1490 nm to be transmitted to the optical fiber, and the optical signal of 1490 nm is multiplexed by means of a wavelength division multiplexing (WDM) method, so that it can be transmitted over a distance of several kilometers (km) to 20 kilometers (km).

The splitter 300 splits the optical signal received from the OLT 100 for transmission to at least one ONU 200. In this regard, the optical signal can be split into a maximum of 32 optical signals. The ONU 200 receives the optical signal split by the splitter 200, and converts it into parallel data which are electrical signals. The ONU 200 line-decodes and MAC-processes the parallel data, and transmits them in an Ethernet frame form or an IP packet form to a subscriber terminal device (not shown).

A collision may occur between the up-link data transmitted from the ONUs 200 to the OLT 100, leading to an error because a maximum of 32 ONUs 200 are connected to one OLT 100 and data from the ONUs 200 are simultaneous concentrated.

In order to resolve a data collision problem in the EPON system, the OLT 100 allocates a time to each ONU 200 based on a multi point control protocol (MPCP) so that each ONU 200 transmits up-link data only during a time allocated to itself.

The multi point control protocol (MPCP) is a MAC control protocol which operates in a master/slave manner, and which performs a bandwidth request and allocation, collision avoidance during an up-link data transmission, and an auto-discovery function and a ranging function of the ONU 200.

The MPCP comprises a registration procedure, a ranging procedure, and a dynamic bandwidth allocation (DBA) procedure.

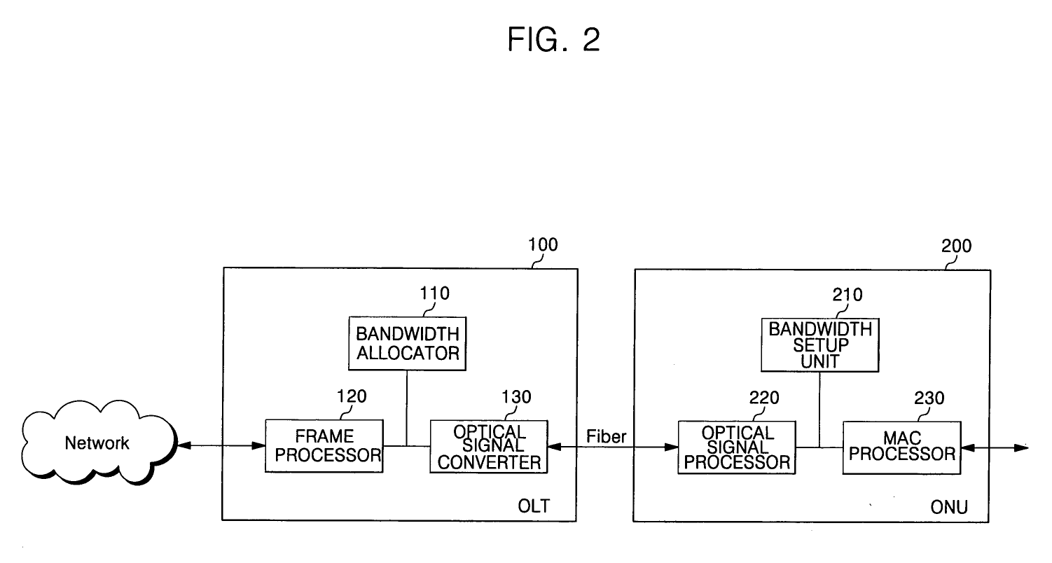

FIG. 2 is a block diagram of an EPO system according to the exemplary embodiment of the present invention.

Referring to FIG. 2, the OLT 100 comprises a bandwidth allocator 110, a frame processor 120, and an optical signal converter 130, and the ONU 200 comprises a bandwidth setup unit 210, an optical signal processor 220, and a MAC processor 230.

The frame processor 120 of the OLT 100 receives the Ethernet frame from the network, and performs MAC protocol processing on it according to the IEEE 802.3ah standard.

The optical signal converter 130 line-codes the MAC-processed Ethernet frame so that it is suitable for the optical fiber, converts it to a serial signal for high speed serial communication, and outputs it to the optical fiber.

The bandwidth allocator 110 allocates a bandwidth to the ONU 200 according to the MPCP. The bandwidth allocator 110 is aware of bandwidth information of the OLT 100.

The optical signal processor 220 of the ONU 200 receives the optical signal split by the splitter 300 via the optical fiber, converts it to parallel data which are electrical signals, and line-decodes them.

The MAC processor 230 performs MAC protocol processing on the parallel data and transmits them to the subscriber terminal device in the Ethernet frame form or the IP packet form.

The bandwidth setup unit 210 registers the ONU 200 in the OLT 100, and sets up a bandwidth allocated from the OLT 100 to exchange the optical signal via the optical fiber. The bandwidth setup unit 210 is aware of bandwidth information of the ONU 200.

According to the present invention, the OLT 100 auto-discovers the ONU 200 and allocates a bandwidth to the ONU by two methods: a first method in which the ONU 200 transmits information about a second bandwidth to the OLT 100, and the OLT 100 checks its first bandwidth and the second bandwidth of the ONU 200 to allocate a bandwidth; and a second method in which the OLT 100 transmits information about the first bandwidth to the ONU 200, and the ONU 200 requests registration according to the first bandwidth of the OLT 100 and its second bandwidth.

More specifically, in the first method, the bandwidth setup unit 210 of the ONU 200 inserts information about the second bandwidth as its bandwidth information (e.g., 1 Gigabit or 2 Gigabit) into a registration request message, and transmits the registration request message to the OLT 100, and the bandwidth allocator 110 of the OLT 100 compares the second bandwidth of the ONU 200 to the first bandwidth which is its allowable bandwidth information (e.g., 1 Gigabit or 2 Gigabit), and registers the ONU 200 therein if the two bandwidths are identical to each other, but otherwise does not register the ONU 200.

In the second method, the bandwidth allocator 110 of the OLT 100 inserts information about the first bandwidth into a discovery gate message, and transmits the discovery gate message to the ONU 200, and the bandwidth setup unit 210 of the ONU 200 compares the first bandwidth to the second bandwidth, and transmits the registration request message to the OLT 100 if the two bandwidths are identical to each other, but otherwise does not transmit it.

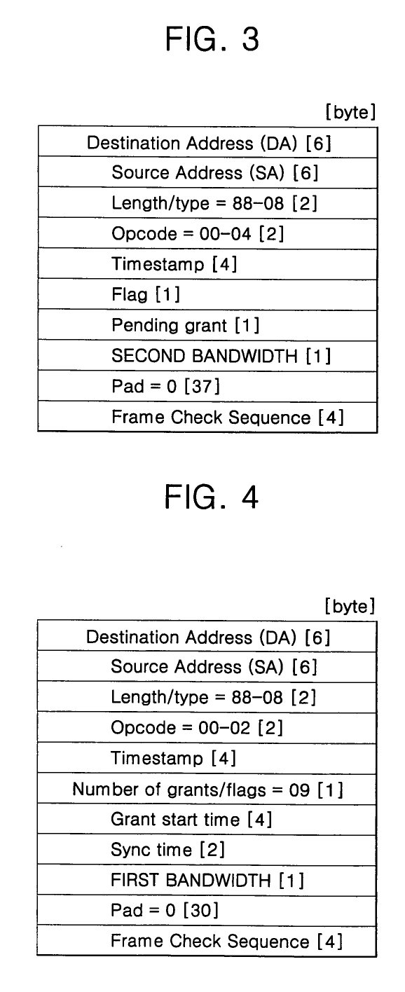

FIG. 3 is a diagram illustrating a registration request message according to an exemplary embodiment of the present invention.

Referring to FIG. 3, the registration request message transmitted from the ONU 200 to the OLT 100 contains information about the second bandwidth of the ONU 200.

The registration request message contains a plurality of fields defined in the MPCP, and thus a detail description of the fields will be omitted.

Among the fields, a field “Opcode” represents a message type, and a field “Flag” represents whether to require a registration request (field value=1) or a registration termination (field value=3).

A field “Sync time” contains a time value obtained by adding an auto gain control (AGC) time value and a clock-and-data recovery (CDR) time value, and a field “Grnae Length” contains a time value obtained by adding a turn on time value, a time value of the field “Sync time”, a data and idle time value, and a turn off time value.

The bandwidth setup unit 210 of the ONU 200 inserts information about the second bandwidth into a 1 byte field of the registration request message, and transmits the registration request message to the OLT 100.

FIG. 4 is a diagram illustrating a discovery gate message according to an exemplary embodiment of the present invention.

Referring to FIG. 4, the discovery gate message periodically broadcast from the OLT 100 to the ONU 200 contains information about the first bandwidth of the OLT 100.

The bandwidth allocator 110 of the OLT 100 inserts information about the first bandwidth into a 1 byte field of the discovery gate message and transmits the discovery gate message to the ONU 200.

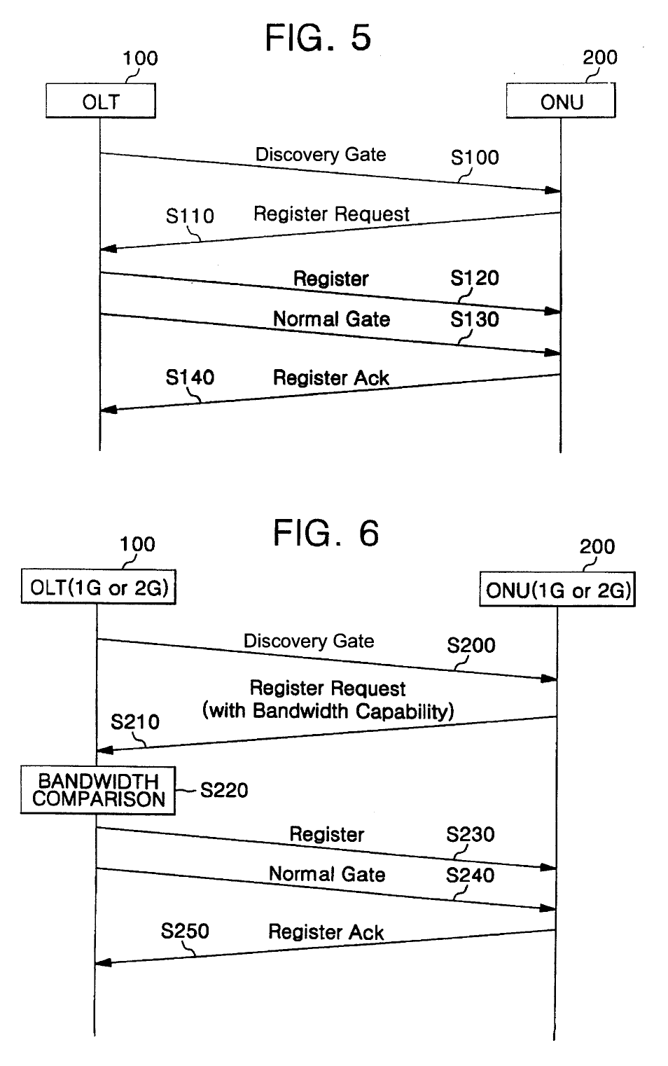

FIG. 5 is a flow diagram of a registration procedure of an EOP system.

Referring to FIG. 5, the ONU 200 is discovered and registered by the auto-discovery function of the OLT 100 and the MPCP.

The OLT 100 periodically broadcasts a discovery gate message “Discovery Gate” (S100).

The ONU 200, which is connected to the optical fiber and is to be newly registered, receives the discovery gate message and transmits the registration request message “Register Request” containing MAC address information to the OLT 100 (S110). That is, the ONU 200 expresses a registration intention.

The OLT 100 transmits a registration message “Register” containing link identification information ID to the corresponding ONU 200 so as to allocate the link identification information ID to the ONU 200 (S120). That is, the OLT 100 notifies the ONU 200 that it confirms the registration intention of the ONU 200.

The OLT 100 allocates a time to transmit up-link data of the ONU 200 and transmits to the ONU 200 a standard gate message “Normal Gate” containing information about the time (S130).

After the ONU 200 is registered in the OLT 100, it transmits a registration acknowledgment message “Register ACK” to the OLT 100 so as to notify that the registration is completed (S140).

The typical registration procedure is suitable for a network environment wherein the OLT 100 and the ONU 200 have the same bandwidth, but it is not suitable for a network environment wherein the OLT 100 and the ONU 200 have different bandwidths (1 Gigabit or 2 Gigabit).

For example, when the ONU 200 having a 1 Gigabit bandwidth registers in the OLT 100 having a 2 Gigabit bandwidth, the ONU 200 cannot receive all data transmitted at a 2 Gigabit bandwidth from the OLT 100, and thus data loss occurs.

Hereinafter, a registration procedure according to the exemplary embodiments of the present invention will be described under the assumption that the OLT 100 supports a 2 Gigabit bandwidth.

FIG. 6 is a flow diagram of a registration procedure according to a first exemplary embodiment of the present invention.

Referring to FIG. 6, the OLT 100 periodically broadcasts a discovery gate message “Discovery Gate” (S200).

The ONU 200, which is connected to the optical fiber and is to be newly registered, receives the discovery gate message and transmits to the OLT 100 a registration request message “Register Request” containing MAC address information and information about the second bandwidth (S20). That is, the ONU 200 transmits the registration request message of FIG. 3 to the OLT 100.

The OLT 100 compares the first bandwidth (e.g., 2 Gigabit) to the second bandwidth of the ONU 200 (S220).

If the first bandwidth is different from the second bandwidth of the ONU 200, i.e., if the second bandwidth of the ONU 200 is 1 Gigabit, the OLT 100 does not transmit the registration message to the ONU 200. That is, the OLT 100 does not register the ONU 200 therein.

If the first bandwidth is identical to the second bandwidth of the ONU 200, i.e., if the second bandwidth of the ONU 200 is 2 Gigabit, the OLT 100 transmits a registration message “Register” containing link identification information ID to the ONU 200 so as to thereby allocate the link identification information ID to the ONU 200 (S230).

The OLT 100 then allocates a time to transmit up-link data of the ONU 200 and transmits to the ONU 200 a standard gate message “Normal Gate” containing information about the time (S240).

After the ONU 200 is registered in the OLT 100, it transmits a registration acknowledgment message “Register ACK” to the OLT 100 so as to notify that the registration is completed (S250).

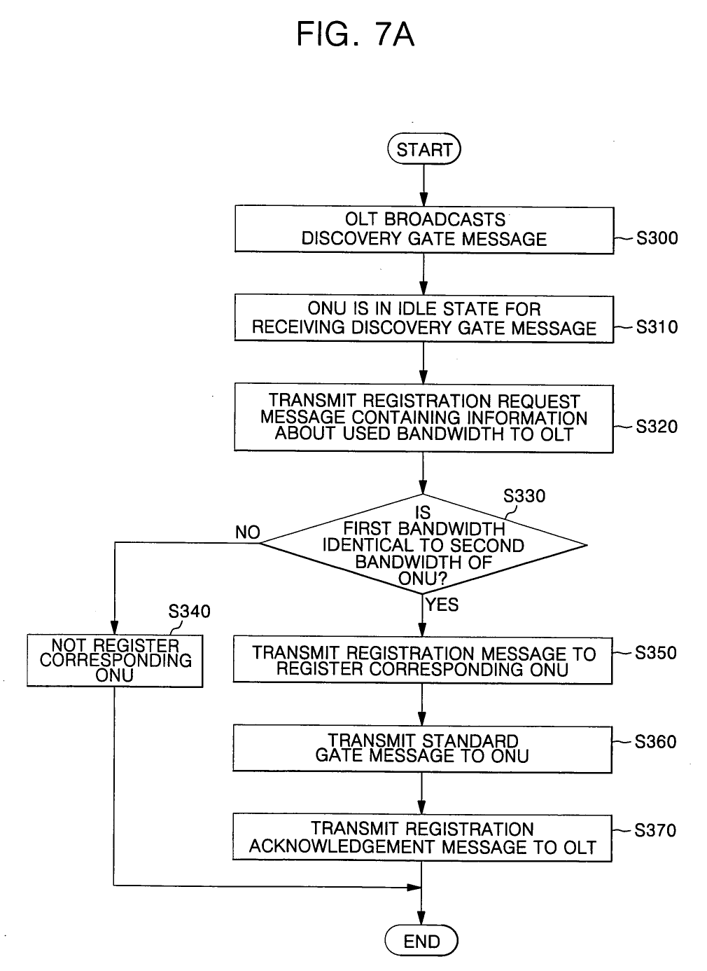

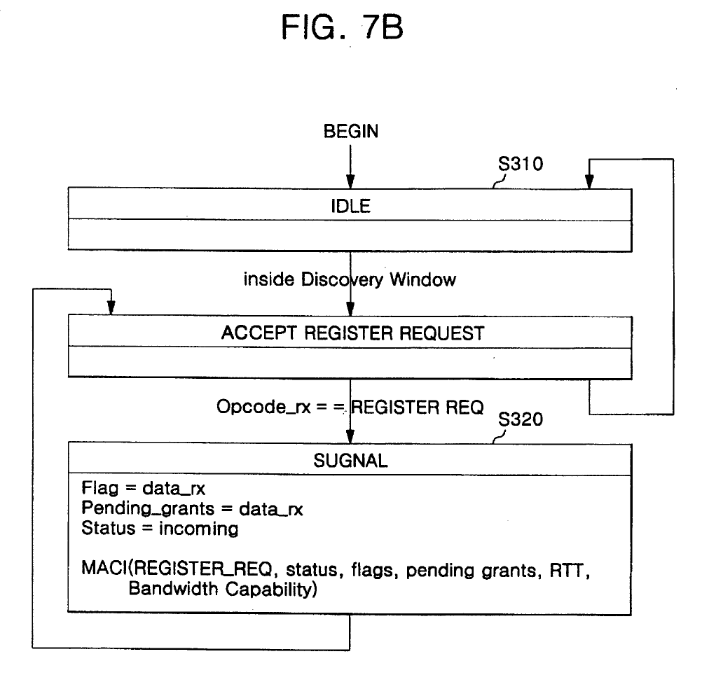

FIG. 7A is a flowchart of the registration procedure according to the first exemplary embodiment of the present invention, and FIG. 7B is a state diagram illustrating that the ONU transmits the registration request message.

Referring to FIGS. 7A and 7B, the OLT 100 periodically broadcasts the discovery gate message “Discovery Gate” (S300).

The ONU 200, which is connected to an optical fiber, and is to be newly registered, waits to receive the discovery gate message (S310). Upon receipt of the discovery gate message, the ONU 200 transmits the registration request message “Register Request”, containing MAC address information and information about the second bandwidth, to the OLT 100 (S320). That is, the ONU 200 transmits the registration request message of FIG. 3 to the OLT 100.

The OLT 100 compares the first bandwidth (e.g., 2 Gigabit) to the second bandwidth of the ONU 200 (S330).

If the first bandwidth is different from the second bandwidth of the ONU 200, i.e., if the second bandwidth of the ONU 200 is 1 Gigabit, the OLT 100 does not transmit the registration message to the ONU 200. That is, the OLT 100 does not register the ONU 200 therein (S340).

If the first bandwidth is identical to the second bandwidth of the ONU 200, i.e., if the second bandwidth of the ONU 200 is 2 Gigabit, the OLT 100 transmits the registration message “Register” containing link identification information ID to the corresponding ONU 200 so as to thereby allocate the link identification information ID to the ONU 200 and to register the ONU 200 (S350).

The OLT 100 then allocates a time to transmit up-link data of the corresponding ONU 200 and transmits the standard gate message “Normal Gate” containing information about the time (S360).

After the ONU 200 is registered in the OLT 100, it transmits to the OLT 100 the registration acknowledgment message “Register ACK” so as to notify that the registration is completed (S370).

The ONU 200 provides an EPON service to a subscribervia the OLT 100.

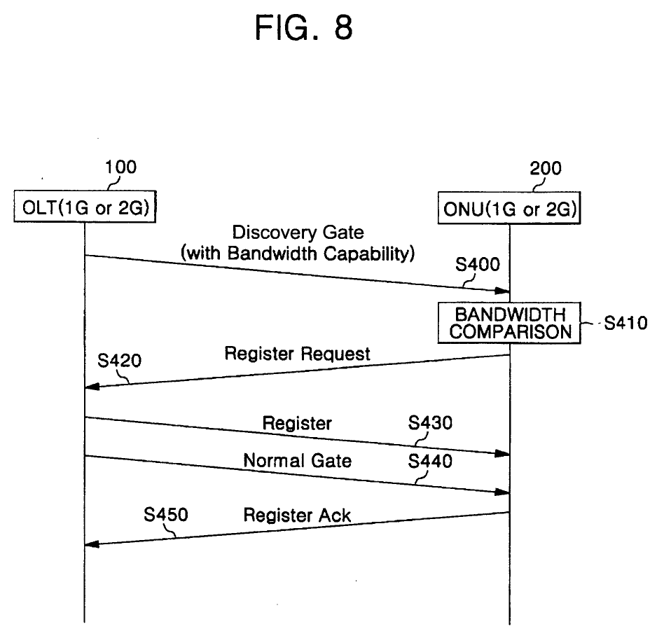

FIG. 8 is a flow diagram of a registration procedure according to a second exemplary embodiment of the present invention.

Referring to FIG. 8, the OLT 100 periodically broadcasts a discovery gate message “Discovery Gate” containing information about the first bandwidth (S400). The OLT 100 broadcasts the discovery gate message of FIG. 4 via the optical fiber.

The ONU 200, which is connected to the optical fiber and is to be newly registered, receives the discovery gate message and compares the first bandwidth contained in the received discovery gate message to the second bandwidth (S410).

If the first bandwidth is different from the second bandwidth, i.e., if the first bandwidth of the OLT 100 is 2 Gigabit and the second bandwidth of the ONU 200 is 1 Gigabit, the ONU 200 does not transmit a registration request message “Register Request” to the OLT 100. That is, the ONU 200 does not register in the EPON system.

If the first bandwidth is identical to the second bandwidth, the ONU 200 transmits the registration request message containing the MAC address information to the OLT 100 (S420).

The OLT 100 transmits a registration message “Register” to the ONU 200, allocates a time to transmit up-link data of the corresponding ONU 200, and transmits a standard gate message “Normal Gate” containing information about the time to the ONU 200 (S430).

After the ONU 200 is registered in the OLT 100, it transmits a registration acknowledgment message “Register ACK” to the OLT 100 so as to notify that the registration is completed (S440).

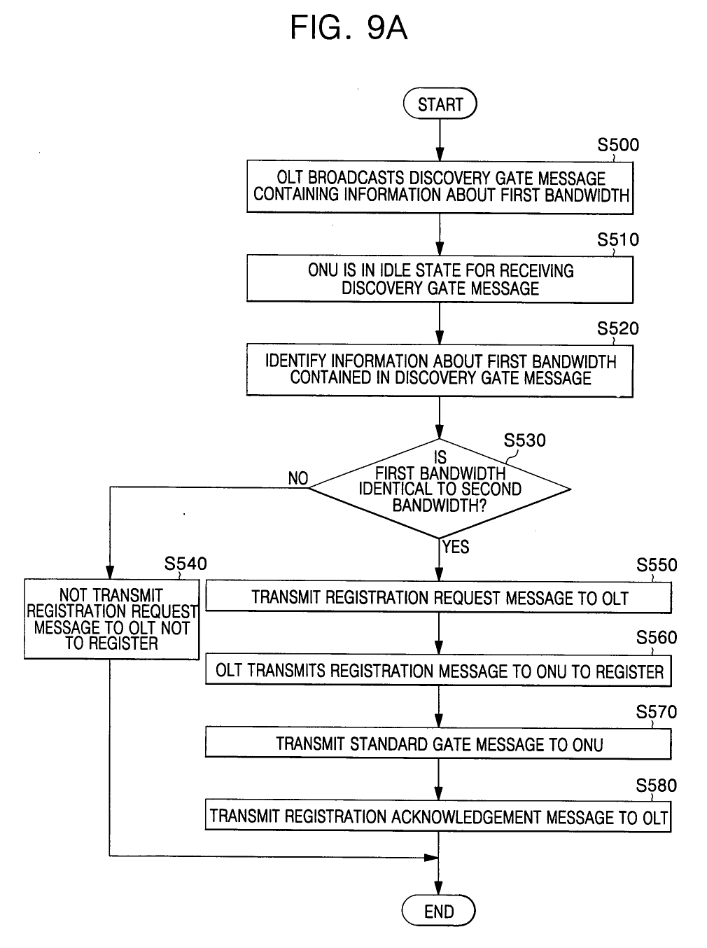

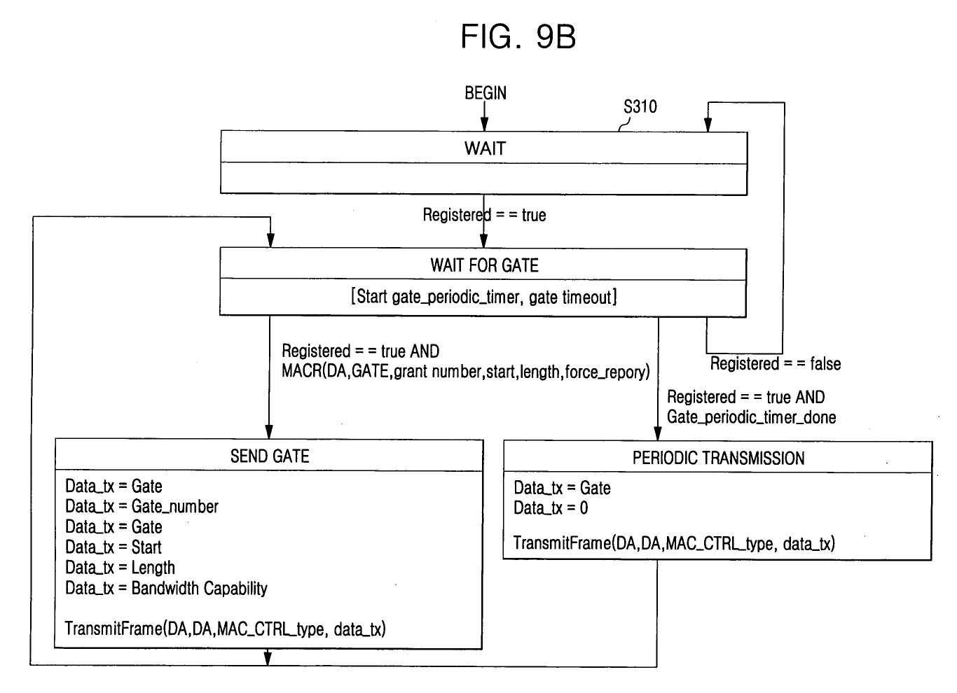

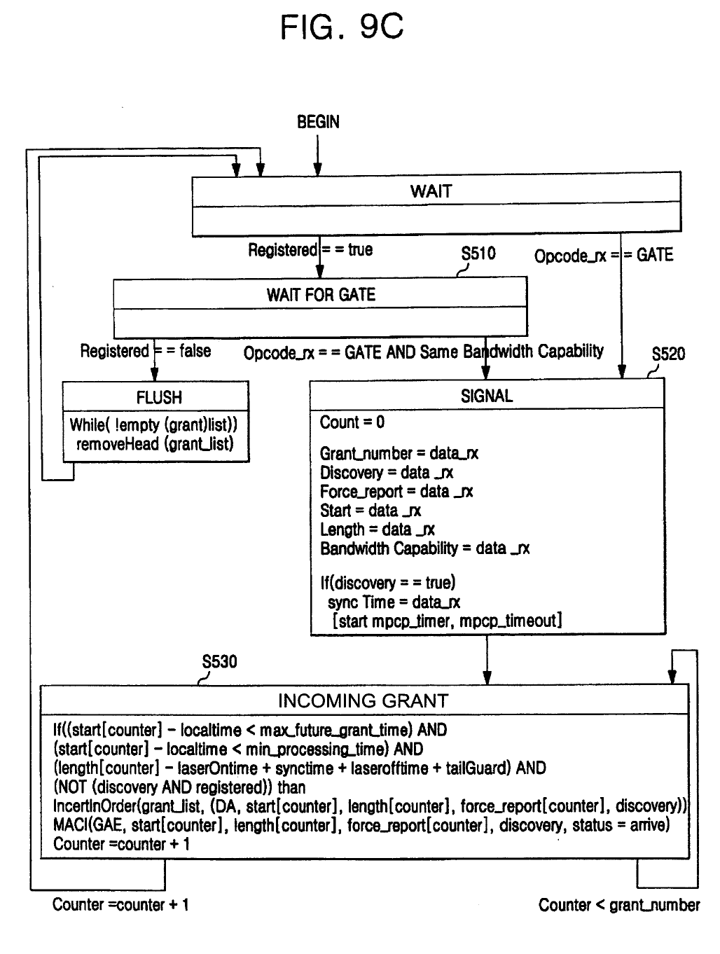

FIG. 9A is a flowchart of the registration procedure according to the second exemplary embodiment of the present invention, FIG. 9B is a state diagram illustrating that an ONU transmits a registration request message, and FIG. 9C is a state diagram illustrating ONU processing according to a bandwidth.

Referring to FIGS. 9A, 9B and 9C, the OLT 100 periodically broadcasts the discovery gate message “Discovery Gate” containing information about the first bandwidth (S500).

The ONU 200, which is connected to the optical fiber and is to be newly registered, waits to receive the discovery gate message (S510), receives the discovery gate message, and identifies the first bandwidth contained in the received discovery gate message (S520).

The ONU 200 compares the first bandwidth contained in the discovery gate message to the second bandwidth (S530). If the first bandwidth is different from the second bandwidth, the ONU 200 does not transmit the registration request message “Register Request” to the OLT 100. That is, the ONU 200 does not register in the EPON system (S540).

If the first bandwidth is identical to the second bandwidth, the ONU 200 transmits the registration request message containing the MAC address information to the OLT 100 (S550).

The OLT 100 receives the registration request message, and then transmits the registration message “Register” containing link identification information ID to the ONU 200 so as to allocate the link identification information to the ONU 200 and to register the ONU 200 (S560).

Then, the OLT 100 allocates a time to transmit up-link data of the ONU 200, and transmits the standard gate message “Normal Gate”, containing information about the time, to the ONU 200 (S570).

After the ONU 200 is registered in the OLT 100, it transmits a registration acknowledgment message “Register ACK” to the OLT 100 so as to notify that the registration is completed (S580).

The ONU 200 provides EPON service to the subscriber via the OLT 100.

The above described exemplary embodiments have been described with respect to bandwidths of 1 Gigabit and 2 Gigabit, but the present invention can be applied to cases wherein the PON system uses other bandwidths, and to cases wherein the registration procedure is performed by a separate bandwidth setup means according to the bandwidths of the OLT and the ONU.

As described above, the EPON system of the present invention can register only ONUs having an optimum bandwidth even though the OLT and the ONU having different bandwidths are used together, thereby preventing data loss.

While the present invention has been described with reference to exemplary embodiments thereof, it will be understood by those skilled in the art that various changes in form and detail may be made therein without departing from the scope of the present invention as defined by the following claims.

What is claimed is:

1. An Ethernet passive optical network (EPON) system, comprising:
at least one optical network unit (ONU) for transmitting a registration request message containing information about a set second bandwidth to an optical line termination (OLT) when a discovery gate message according to a multi point control protocol (MPCP) is received;
wherein the OLT registers said at least one ONU therein according to information about a set first bandwidth and the information about the second bandwidth contained in the registration request message received from said at least one ONU.

2. The system of claim 1, wherein said at least one ONU produces the registration request message which contains the information about the second bandwidth in a predetermined byte size field.

3. The system of claim 1, wherein the OLT registers said at least one ONU therein when the first bandwidth is identical to the second bandwidth, and wherein the OLT does not register said at least one ONU therein when the first bandwidth is not identical to the second bandwidth.

4. The system of claim 1, wherein said at least one ONU comprises:
an optical signal processor for converting an optical signal received via an optical fiber into parallel data which are electrical signals, and for line-decoding the parallel data;
a MAC processor for MAC-processing the parallel data, and for providing one of an Ethernet frame and an IP packet to a subscriber terminal device; and
a bandwidth setup unit for recognizing the second bandwidth of said at least one ONU, and for producing the registration request message containing the information about the second bandwidth when the discovery gate message is received.

5. The system of claim 1, wherein the OLT comprises:
a frame processor for performing MAC protocol processing of an Ethernet frame received from a network according to an IEEE 802.3ah standard;
an optical signal processor for line-coding the MAC protocol-processed Ethernet frame, and for converting the Ethernet frame to a serial signal, and for transmitting the serial signal to an optical fiber; and
a bandwidth allocator for broadcasting the discovery gate message via the optical fiber, for comparing the second bandwidth contained in the registration request message received from said at least one ONU to the first bandwidth of the OLT, for registering said at least one ONU therein, and for transmitting a registration message containing link identification information when the first bandwidth and the second bandwidth are identical.

6. The system of claim 1, wherein the OLT allocates an up-link data transmission time of the registered said at least one ONU, and transmits a standard gate message containing information about the time to said at least one ONU.

7. The system of claim 1, further comprising a splitter which is located between the OLT and said at least one ONU, and which splits an optical signal exchanged via an optical fiber to connect the OLT and said at least one ONU.

8. An EPON system, comprising:
an OLT for broadcasting a discovery gate message containing information about a set first bandwidth; and
at least one ONU for recognizing the information about the first bandwidth contained in the discovery gate message received from the OLT, for comparing information about a set second bandwidth to the information about the first bandwidth, for transmitting a registration request message when the information about the first bandwidth is identical to the information about the second bandwidth, and for not registering in the OLT when the information about the first bandwidth width is not identical to the information about the second bandwidth.

9. The system of claim 8, wherein the OLT produces the discovery gate message which contains the information about the set first bandwidth in a predetermined byte size field.

10. The system of claim 8, wherein the OLT comprises:
a frame processor for performing MAC protocol processing of an Ethernet frame received from a network according to an IEEE 802.3ah standard;
an optical signal processor for line-coding the MAC protocol-processed Ethernet frame, for converting the Ethernet frame to a serial signal, and for transmitting the serial signal to an optical fiber; and
a bandwidth allocator for broadcasting the discovery gate message containing the information about the first bandwidth via the optical fiber, and responsive to receipt of the registration request message from said at least one ONU for registering the corresponding said at least one ONU therein, for transmitting a registration message containing link identification information to the corresponding said at least one ONU, and for transmitting to said at least one ONU a standard gate message containing up-link data transmission time information allocated to the ONU.

11. The system of claim 8, wherein said at least one ONU comprises:
an optical signal processor for converting an optical signal received via an optical fiber to parallel data which are electrical signals, and for line-decoding the parallel data;
a MAC processor for MAC-processing the parallel data, and for providing one of an Ethernet frame and an IP packet to a subscriber terminal device; and
a bandwidth setup unit for transmitting the registration request message to the OLT when the information about the second bandwidth of said at least one ONU is identical to the information about the first bandwidth contained in the discovery gate message, and for not registering said at least one ONU to the OLT when the information about the second bandwidth of said at least one ONU is not identical to the information about the first bandwidth.

12. A method for setting up a bandwidth in an EPON system which includes at least one ONU and an OLT, the method comprising the steps of:
at said at least one ONU, transmitting to the OLT a registration request message containing information about a second bandwidth set to said at least one ONU when a discovery gate message according to an MPCP is received;
at the OLT, comparing the information about the second bandwidth contained in the registration request message to information about a first bandwidth set to the OLT; and
at the OLT, registering said at least one ONU therein and transmitting a registration message when the first bandwidth is identical to the second bandwidth.

13. The method of claim 12, wherein the registration request message contains the information about the second bandwidth in a predetermined byte size field.

14. The method of claim 12, further comprising the step, at the OLT, of not registering said at least one ONU therein when the first bandwidth is not identical to the second bandwidth.

15. The method of claim 12, further comprising the steps of:
at the OLT, registering said at least one ONU therein and transmitting the registration message containing link identification information;
at the OLT, allocating an up-link data transmission time of the registered said at least one ONU and transmitting a standard gate message containing information about the time to said at least one ONU; and
at said at least one ONU, transmitting a registration acknowledgment message to the OLT.

16. The method of claim 12, further comprising the steps of:
at the OLT, performing MAC protocol processing of an Ethernet frame received from a network according to an IEEE 802.3ah standard;
at the OLT, line-coding the MAC protocol-processed Ethernet frame, converting the Ethernet frame to a serial signal, and transmitting the serial signal to an optical fiber;
at said at least one ONU, converting the optical signal received via an optical fiber to parallel data which are electrical signals, and line-decoding the parallel data; and
at said at least one ONU, MAC-processing the parallel data and providing one of an Ethernet frame and an IP packet to a subscriber terminal device.

17. A method for setting up a bandwidth in an EPON system which includes at least one ONU and an OLT, the method comprising the steps of:
at the OLT, broadcasting a discovery gate message containing information about a first bandwidth set to the OLT;
at said at least one ONU, identifying the information about the first bandwidth from the discovery gate message; and
at said at least one ONU, transmitting a registration request message to the OLT when information about a second bandwidth set to said at least one ONU is identical to the information about the first bandwidth.

18. The method of claim 17, wherein the discovery gate message contains the information about the first bandwidth in a predetermined byte size field.

19. The method of claim 17, further comprising the step, at said at least one ONU, of not transmitting the registration request message when the information about the second bandwidth set to said at least one ONU is not identical to the information about the first bandwidth.
